(19) United States
(12) Patent Application Publication
(10) Pub. No.: US 2005/0031793 A1
(43) Pub. Date: Feb. 10, 2005

(54) Stellate prepolymers for the production of ultra-thin coatings that form hydrogels

(76) Inventors: Martin Moeller, Aachen (DE); Claudia Mourran, Aachen (DE); Joachim Spatz, Heidenheim (DE); Haitao Rong, Darmstadt (DE)

Correspondence Address: HENKEL CORPORATION, THE TRIAD, SUITE 200, 2200 RENAISSANCE BLVD., GULPH MILLS, PA, 19406, US

(21) Appl. No.: 10/901,751

(22) Filed: Jul. 29, 2004

Related U.S. Application Data
(63) Continuation of application No. PCT/EP03/00726, filed on Jan. 24, 2003.

(30) Foreign Application Priority Data
Feb. 1, 2002 (DE) 102 03 937.2
Apr. 15, 2002 (DE) 102 16 639.0

(51) Int. Cl. B05D 3/02

(52) U.S. Cl. 427/384

(57) ABSTRACT

Stellate polymers containing hydrophilic polymer arms, which bear reactive functional groups on their free ends, are useful for producing ultra-thin coatings that form hydrogels. Such coatings actively suppress an unspecific protein absorption on surfaces provided with such coatings.

### CROSS-REFERENCE TO RELATED APPLICATIONS

This application is a continuation under 35 USC Sections 365(c) and 120 of International Application No. PCT/EP03/00726 filed 24 Jan. 2003 and published 7 Aug. 2003 as WO 03/051601, which claims priority from German Application No. 10203937.2, filed 1 Feb. 2002, and German Application No. 10216639.0, filed 15 Apr. 2002, each of which is incorporated herein by reference in its entirety.

### FIELD OF THE INVENTION

This invention relates to the use of star-like polymers with hydrophilic polymer arms which carry a reactive functional group R at their free ends for the production of ultra-thin hydrogel-forming coatings. The hydrogel-forming coatings obtained effectively suppress the non-specific adsorption of proteins onto correspondingly treated surfaces.

### DISCUSSION OF THE RELATED ART

The specific and non-specific interaction of proteins and cells with artificial surfaces forms the basis of many medical, biochemical and biotechnological applications. In order to prevent unwanted deposits (also known as biofouling and plaque) and to stimulate the desirable colonization by cells, any non-specific protein and cell adsorption has to be suppressed. Since biological systems are themselves capable of actively modifying their environment (surfaces), the cells have to be prevented from conditioning their environment by membrane proteins or extracellular matrix proteins in a way that prepares non-specific cell colonization if non-specific protein and cell adsorption is to be reduced.

Utilizing specific adsorption processes for analysis naturally requires exact control of the type, quantity and conformation of non-specifically adsorbed molecules or, better yet, the total suppression of non-specific adsorption. In order to detect biomolecules that are only present in extremely small quantities, it is important to ensure that the substances to be detected are not lost by non-specific adsorption en route to detection.

The suppression of non-specific protein adsorption and cell colonization is also important in the medical field, for example in the case of catheters, contact lenses or prostheses. For prostheses and implants, the selective suppression of non-specific adsorption processes forms a precondition for enabling molecules and cells to be specifically coupled by incorporation of ligands, signal substances and growth factors, thereby promoting healing and the growing in of biological tissue.

In addition, the prevention of biological deposits of proteins or bacteria plays a key role in the field of hygiene and in keeping clean surfaces which cannot permanently be completely cleaned. Also, unwanted biological deposits on extremely large wetted surfaces, such as ships' hulls, water tanks and the like, and deposits in inaccessible places, such as large pipe systems, represent a major economic problem. The anti-plaque coatings used at present are mostly toxic organometallic compounds or lose their bactericidal effect very quickly.

Accordingly, the formation of plaque and biofouling represent a serious economic and ecological problem which, hitherto, has not been satisfactorily solved.

Polymeric coatings and, in particular, polymeric hydrogel-forming coatings have been variously proposed for avoiding the non-specific adsorption of proteins onto surfaces. Hydrogel-forming coatings are coatings that are swollen by water. Thus, adsorbate layers of polyethylene glycol (PEG) reduce the subsequent adsorption of proteins from biological media (see, for example, Merrill E. W., in Poly(ethylene glycol) Chemistry, Ed. J. M. Harris, pp 199-220, Plenum Press, New York: 1992; C.-G. Gölander, Jamea N. Herron, Kap Lim, P. Claesson, P. Stenius, J. D. Andrade, in Poly(ethylene glycol) Chemistry, Ed. J. M. Harris, Plenum Press, New York: 1992). Polymer surfaces modified with poly(ethylene oxide) to reduce protein adsorption onto implant materials have also been intensively studied in recent years (Paine et al., Macromolecules 1990, 23, p. 3104).

U.S. Pat. No. 5,993,890 describes triblock copolymers comprising a polysaccharide block, for example a heparin or dextran block, and hydrophobic hydrocarbon residues. The polymers are particularly suitable for preventing the adsorption of proteins onto hydrophobic surfaces.

EP 272842 A2 describes coatings with a low affinity for proteins which are produced by application of compositions of hydroxyfunctional polymers, for example cellulose derivatives, and crosslinking agents, for example copolymers of acrylic acid and N-methylol acrylamide, to microporous substrates and subsequent crosslinking of the coating.

EP 335308 A2 describes the use of prepolymers of polyethylene oxide diols and triols, of which the terminal OH groups have been reacted with polyisocyanates, for the production of coatings with low non-specific protein adsorption.

U.S. Pat. No. 6,087,415 discloses antimicrobial coatings for biomedical articles, such as contact lenses, which are produced by coupling of carboxyfunctional polymers onto the OH or NH₂ groups on the surface of the biomedical article.

In addition, U.S. Pat. Nos. 6,150,459 and 6,207,749 describe for this purpose synthetic comb polymers which have a hydrophobic polymer backbone, for example a polylactide or a polymer derived from methyl methacrylate, and—grafted thereon—hydrophilic polymer chains preferably derived from polyethylene glycols or polyacrylic acid.

J. Rühe et al. (Prucker, O. and Rühe, J.: Langmuir 1998, 14(24), 6893-6898; Macromolecules, 1998 31(3), 592-601; Macromolecules, 1998, 31(3), 602-613) describe a coating process in which a surface is first modified with a monolayer of an initiator which is then used to initiate a radical polymerization. Very thick layers are formed and can grow to several hundred nanometers in thickness.

Cruise et al. (Biomaterials 1998, 19, 1287-1294) and Han et al. (Macromolecules 1997, 30, 6077-6083.0) describe the use of acrylate-terminated prepolymers produced either from PEG diols or PEG triols for the production of hydrogel layers. For fixing to the surface, the acrylate-terminated prepolymer is exposed to light on a suitably pretreated substrate, so that the prepolymer crosslinks either on its own or with acrylate-terminated glycerol triol in the presence of added benzene dimethylketal to form a hydrogel. Hydrogel layers with layer thicknesses of 135 μm to 180 μm are obtained in this way. Proposed applications for these hydrogel layers include their in vivo use, for example for suppressing post-operative adhesion processes, their use as diffusion barriers, for the bonding or sealing of tissues, for in vivo medicamentation and their use as a direct implant, for example in the form of a hydrogel cell suspension, peptide hydrogel or a growth factor hydrogel.

Although the hydrogel-forming coatings known from the prior art do reduce non-specific cell and protein adsorption, the long-term resistance of the coatings is often unsatisfactory. In other cases, the barrier effect for proteins is inadequate. In many cases, complicated production processes for these coatings prevent their widescale use, particularly on irregularly shaped surfaces. Accordingly, the problem addressed by the present invention was to provide suitable processes for the production of extremely thin, hydrogel-forming coatings which would reproducibly form dense and controllable layers, would possess sufficiently high long-term resistance to protein and cell adsorption and could be universally used, i.e. would lend themselves to broad use for material coatings. In addition, it would be possible to incorporate specific functional molecules into the layers or to anchor them to the surface in a defined manner. Ideally, the coatings would be able to be applied as ultra-thin, molecularly smooth films in the fields of application mentioned. Defined functionalities would also be able to be introduced into the coatings. In addition, the coating process would advantageously be able to be carried out even from aqueous preparations. In this case, existing processes for the production of the substrates and components would not be adversely affected by the use of hydrogel coatings and would be able to be used in various fields of application.

### BRIEF SUMMARY OF THE INVENTION

It has been found that the problem stated above can be solved by coatings based on inter-crosslinked star-like prepolymers having, on average, at least four polymer arms A which are individually soluble in water and, at their free ends, carry a reactive functional group R which reacts with a complementary reactive functional group R′ or with itself to form a bond.

Accordingly, the present invention relates to the use of star-like prepolymers having, on average, at least four polymer arms A which are individually soluble in water and, at their free ends, carry a reactive functional group R which reacts with a complementary group R′ or with itself to form a bond for the production of ultra-thin hydrogel-forming coatings.

The present invention also relates to a process for the production of ultra-thin, hydrogel-forming coatings which is characterized in that
i. a solution of a star-like prepolymer having, on average, at least four polymer arms A which are individually soluble in water and, at their free ends, carry a reactive functional group R is applied to the surface to be coated and
ii. a reaction is then carried out to crosslink the reactive groups with one another.

### BRIEF DESCRIPTION OF THE DRAWINGS

FIG. 1 shows the ellipsometrically determined layer thickness of a coating according to the invention as a function of the number of coating steps.

FIG. 2 shows the increase in the thickness of a dried coating according to the invention exposed to atmospheric moisture (determined by ellipsometry).

FIG. 3 is an optical micrograph of a glass plate coated in accordance with the invention (coating thickness ca. 50 nm) which has been incubated with a fibroblast suspension.

FIGS. 4a and 4b are optical micrographs of glass plates which have a coating according to the invention on one half and a polystyrene coating on the other half and which have been incubated with a fibroblast suspension.

FIG. 5 is an optical micrograph of a glass plate which was half-coated with a mixture of star prepolymers and dextran (1:1) and half-uncoated and which had been incubated with a fibroblast suspension.

### DETAILED DESCRIPTION OF CERTAIN EMBODIMENTS OF THE INVENTION

A hydrogel-forming coating is understood by the expert to be a coating which is swollen by water in consequence of the intercalation of water molecules into the coating.

Star-like polymers are understood to be polymers which have several polymer chains bound to a low molecular weight central unit, the low molecular weight central unit generally having 4 to 100 skeletal atoms, such as C atoms, N atoms or O atoms. Accordingly, the star-like polymers used in accordance with the invention may be represented by the following general formula I:
Z(A-B—R)ₙ (I)
in which
n is an integer with a value of at least 4, for example 4 to 12, preferably 5 to 12 and more particularly 6 to 8;
Z is a low molecular weight n-functional organic residue as the central unit which generally has 4 to 100 and preferably 5 to 50 skeletal atoms, more particularly 6 to 30 skeletal atoms. The central unit may have both aliphatic and aromatic groups. For example, it stands for a residue derived from an at least 4-hydric alcohol, for example a 4- to 12-hydric, preferably an at least 5-hydric and more particularly a 6- to 8-hydric alcohol, for example pentaerythritol, dipentaerythritol, a sugar alcohol, such as erythritol, xylitol, mannitol, sorbitol, maltitol, isomaltulose, isomaltitol, trehalulose or the like;
A is a hydrophilic polymer chain which is soluble in water as such;
B is a chemical bond or a difunctional, low molecular weight organic residue containing preferably 1 to 20 and more particularly 2 to 10 carbon atoms, for example a C₂₋₁₀ alkylene group, a phenylene group or a naphthylene group or a C₅₋₁₀ cycloalkylene group; the phenylene, naphthylene or cycloalkylene group may additionally bear one or more, for example 1, 2, 3, 4, 5 or 6 substituents, for example C₁₋₄ alkyl groups, C₁₋₄ alkoxy groups or halogen; and
R is a reactive group which is capable of reacting with a complementary reactive functional group R′ or with itself to form a bond.

Reactive groups R in this context are groups which react with nucleophiles in an addition or substitution reaction, for example isocyanate groups, (meth)acryl groups, oxirane groups, oxazoline groups, carboxylic acid groups, carboxylic acid ester and carboxylic anhydride groups, carboxylic acid and sulfonic acid halide groups, but also the complementary groups reacting as a nucleophile, such as alcoholic OH groups, primary and secondary amino groups, thiol groups and the like. Examples of carboxylic ester groups are, in particular, so-called active ester groups with the formula —C(O)O—X, where X represents pentafluorophenyl, pyrrolidine-2,5-dion-1-yl, benzo-1,2,3-triazol-1-yl or a carboxamidine residue.

Other suitable reactive groups R are radically polymerizable C═C double bonds, for example vinyl ether and vinyl ester groups besides the (meth)acryl groups mentioned above, activated C═C double bonds, activated C≡C triple bonds and N═N double bonds which react with allyl groups in an ene reaction or with conjugated diolefin groups in a Diels-Alder reaction. Examples of groups which are capable of reacting with allyl groups in an ene reaction or with dienes in a Diels-Alder reaction are maleic acid and fumaric acid groups, maleic acid ester and fumaric acid ester groups, cinnamic acid ester groups, propiolic acid (ester) groups, maleic acid amide and fumaric acid amide groups, maleic imide groups, azodicarboxylic acid ester groups and 1,3,4-triazoline-2,5-dione groups.

In a preferred embodiment, the star-like prepolymer has functional groups which are accessible to an addition or substitution reaction by nucleophiles. Such groups also include groups which react in a Michael reaction. Examples are, in particular, isocyanate groups, (meth)acryl groups (react in a Michael reaction), oxirane groups or carboxylic acid ester groups. A particularly preferred embodiment relates to star-like prepolymers which contain isocyanate groups as reactive groups R.

In another embodiment, the prepolymer contains ethylenically unsaturated, radically polymerizable double bonds as reactive groups R.

In order to obtain compact layers, the star-like prepolymer must have, on average, at least 4, for example 4 to 12, preferably at least 5 and more particularly 6 to 8 polymer arms. The number average molecular weight of the polymer arms is preferably in the range from 300 to 3,000 g/mol and more particularly in the range from 500 to 2,000 g/mol. Accordingly, the star-like prepolymer has a number average molecular weight of 2,000 to 20,000 g/mol and, more particularly, 2,500 to 15,000 g/mol.

The molecular weight may be determined in known manner by gel permeation chromatography using commercially available columns, detectors and evaluation software. Where the number of terminal groups per polymer molecule is known, the molecular weight may also be determined by titration of the terminal groups—in the case of isocyanate groups, for example, by reaction with a defined quantity of a secondary amine, such as dibutylamine and subsequent titration of the excess amine with acid.

Adequate swellability of the coating by water is guaranteed by the solubility of the polymer arms A in water. Adequate swellability of the coating by water is generally guaranteed when the molecular structure, i.e. at least the nature of the recurring units and preferably also the molecular weight of the polymer arm, corresponds to a polymer of which the solubility in water amounts to at least 1% by weight and preferably to at least 5% by weight (at 25° C./1 bar).

Examples of such polymers with adequate solubility in water are poly-C₂₋₄-alkylene oxides, polyoxazolines, polyvinyl alcohols, homopolymers and copolymers containing at least 50% by weight (co)polymerized N-vinyl pyrrolidone, homopolymers and copolymers containing at least 30% by weight (co)polymerized hydroxyethyl (meth)acrylate, hydroxypropyl(meth)acrylate, acrylamide, methacrylamide, acrylic acid and/or methacrylic acid, hydroxylated polydienes and the like.

In a preferred embodiment, the polymer arms A are derived from poly-C₂₋₄-alkylene oxides and are selected in particular from polyethylene oxide, polypropylene oxide and polyethylene oxide/polypropylene oxide copolymers which may have a block or statistical arrangement of the recurring units. Star-like prepolymers of which the polymer arms A are derived from polyethylene oxides or from polyethylene oxide/polypropylene oxide copolymers with a percentage propylene oxide content of not more than 50% are particularly preferred.

The prepolymers used in accordance with the invention are partly known, for example from WO 98/20060, U.S. Pat. No. 6,162,862 (polyether star polymers), Chujo Y. et al., Polym. J. 1992, 24(11), 1301-1306 (star-like polyoxazolines), WO 01/55360 (star-like polyvinyl alcohols, star-like copolymers containing vinyl pyrrolidone) or may be produced by the methods described therein.

The star-like prepolymers used in accordance with the invention are generally produced by functionalization of suitable star-like prepolymer precursors which already have the above-described prepolymer structure, i.e. at least four water-soluble polymer arms, and which at the end of each polymer arm have a functional group R″ that can be converted into one of the above-mentioned reactive groups R. The groups R″ include halogen atoms, more particularly chlorine, bromine or iodine, attached to aliphatic or aromatic C atoms, preferably to a primary aliphatic C atom, OH groups, thiol groups and NHR² groups (R²=hydrogen or C₁₋₄ alkyl) attached to an aliphatic or aromatic C atom and more particularly to a primary aliphatic C atom. Prepolymer precursors such as these are known from the prior art, for example from U.S. Pat. No. 3,865,806, U.S. Pat. No. 5,872,086, U.S. Pat. No. 6,162,862, Polym. J. 1992, 24(11), 1301-1306, WO 01/55360 and are commercially available, for example in the case of star-like poly-C₂₋₄-alkylene oxides under the names of VORANOLO®, TERRALOX®, SYNALOX® and DOWFAX® of Dow Chemical Corporation, SORBETH® of Glyco-Chemicals, Inc. and GLUCAM® of Amerchol Corp., or can be produced by known methods of polymer chemistry by polymerization of suitable monomers in the presence of polyfunctional starters, for example by “living” polymerization (cf. Hsieh, H. L.; Quirk, R. P.: Anionic polymerization: Principles and Practical Applications, New York, Marcel Dekker, 1996; Matyjaszewski, K.: Controlled/Living radical polymerization: Progress in ATRP, NMP and RAFT, Washington, D.C.: American Chemical Society, 2000) or—in the particular case of ethylenically unsaturated monomers—by atom transfer radical polymerization (ATRP) using the method described in WO 98/40415.

Basically, the functionalization of the star-like prepolymer precursors may be carried out similarly to known functionalization processes.

Suitable starting materials for the production of prepolymers carrying amino groups at the ends of the polymer arms A are, in particular, prepolymer precursors which have OH groups at the ends of the polymer arms A. The OH groups may be converted into amino groups, for example, by the method described by Skarzewski, J. et al. in Monatsh. Chem. 1983, 114, 1071-1077. To this end, the OH groups are converted into the corresponding halide with a halogenating agent, such as thionyl chloride, sulfuryl chloride, thionyl bromide, phosphorus tribromide, phosphorus oxychloride, oxalyl chloride and the like, optionally in the presence of an auxiliary base, such as pyridine or triethylamine, or into the corresponding mesylate with methane sulfonyl chloride using methods known per se (cf. Organikum, 15th Edition, VEB, Berlin 1981, pages 241 et seq.; J. March, Advanced Organic Synthesis, 3rd Edition, pages 382 et seq.; see also Example 12). The halogen compound thus obtained or the mesylate is then converted with an alkali metal azide into the corresponding azide, preferably in an aprotic polar solvent, such as dimethyl sulfoxide, dimethyl formamide, dimethyl acetamide or N-methyl pyrrolidone. The azide is then converted into the amino compound either with hydrogen in the presence of a transition metal catalyst or with a complex hydride, such as lithium aluminium hydride.

Prepolymers carrying oxirane groups at the ends of the polymer arms A are produced, for example, by reaction of prepolymer precursors carrying OH groups at the ends of the polymer arms A with glycidyl chloride.

Prepolymers carrying (meth)acryl groups at the ends of the polymer arms A are produced, for example, by esterification of prepolymer precursors carrying OH groups at the ends of the polymer arms A with acrylic or methacrylic acid or by reaction of the OH groups with (meth)acryl chloride using known methods. Alternatively, the NH₂ groups in prepolymer precursors carrying NH₂ groups at the ends of the polymer arms A may be reacted with (meth)acrylic acid or acid chlorides thereof. (Meth)acrylate-terminated prepolymers may be produced, for example, by the methods described by Cruise et al. in Biomaterials, 1998, 19, 1287-1294 and Han et al. in Macromolecules 1997, 30, 6077-6083 for the modification of polyether diols and triols.

Prepolymers carrying thiol groups at the ends of the polymer arms A are produced, for example, by reaction of prepolymer precursors which carry halogen atoms at the ends of the polymer arms A with thioacetic acid and subsequent hydrolysis using the method described in Houben-Weyl, Methoden der Organischen Chemie. Ed. E. Müller, 4th Edition, Vol. 9, p. 749, G. Thieme, Stuttgart 1955.

Prepolymers carrying isocyanate at the ends of the polymer arms A are preferably produced by addition of a low molecular weight diisocyanate onto prepolymer precursors which have OH, SH or NHR″ groups (R″=H or an aliphatic radical) at the ends of the polymer arms A. Star-like polyols with terminal OH groups are preferably used.

Suitable diisocyanates are both aromatic diisocyanates, such as toluene-2,4-diisocyanate, toluene-2,6-diisocyanate, commercially obtainable mixture of toluene-2,4- and -2,6-diisocyanate (TDI), m-phenylene diisocyanate, 3,3′-diphenyl-4,4′-biphenylene diisocyanate, 4,4′-biphenylene diisocyanate, 4,4′-diphenylmethane diisocyanate, 3,3′-dichloro-4,4′-biphenylene diisocyanate, cumene-2,4-diisocyanate, 1,5-naphthalene diisocyanate, p-xylylene diisocyanate, p-phenylene diisocyanate, 4-methoxy-1,3-phenylene diisocyanate, 4-chloro-1,3-phenylene diisocyanate, 4-bromo-1,3-phenylene diisocyanate, 4-ethoxy-1,3-phenylene diisocyanate, 2,4-dimethyl-1,3-phenylene diisocyanate, 5,6-dimethyl-1,3-phenylene diisocyanate, 2,4-diisocanatodiphenylether, benzidine diisocyanate, 4,6-dimethyl-1,3-phenylene diisocyanate, 9,10-anthracene diisocyanate, 4,4′-diisocyanatodibenzyl, 3,3′-dimethyl-4,4′-diisocyanatodiphenylmethanes, 2,6-dimethyl-4,4′-diisocyanatodiphenyl, 2,4-diisocyanatostilbene, 3,3′-dimethoxy-4,4′-diisocyanatodiphenyl, 1,4-anthracene diisocyanate, 2,5-fluorene diisocyanate, 1,8-naphthalene diisocyanate, 2,6-diisocyanatobenzofuran, and aliphatic and cycloaliphatic diisocyanates, such as isophorone diisocyanate, (IPDI), ethylene diisocyanate, ethylidene diisocyanate, propylene-1,2-diisocyanate, cyclohexylene-1,2-diisocyanate, cyclohexylene-1,4-diisocyanate, 1,6-hexamethylene diisocyanate, 1,4-tetramethylene diisocyanate, 1,10-decamethylene diisocyanate and methylene dicyclohexyl diisocyanate.

Diisocyanates of which the isocyanate groups differ in their reactivity, such as toluene-2,4-diisocyanate, toluene-2,6-diisocyanate and mixtures of toluene-2,4- and -2,6-diisocyanate and cis- and trans-isophorone diisocyanate, are preferred.

Star-like prepolymers terminated by aliphatic diisocyanate groups, particularly those obtained by addition of IPDI onto the chain ends of OH-terminated star-like prepolymer precursors, are particularly preferred.

The star polymers are of course reacted with the diisocyanate in such a way that one diisocyanate unit is added onto each chain end of the star molecules, the second isocyanate group of the diisocyanate remaining free. In this way, each terminal group of the star molecules is provided with a free isocyanate group via a urethane linkage. Corresponding processes are known, for example, from U.S. Pat. No. 5,808,131, WO 98/20060 and U.S. Pat. No. 6,162,862 and Bartelink, C. F. et al., J. Polymer Science 2000, 38, 2555-2565.

To this end, the prepolymer precursor will generally be added to an excess of the diisocyanate in order to avoid the formation of multimeric adducts, i.e. adducts in which two or more prepolymers are linked to one another by diisocyanate units. The excess generally amounts to at least 10 mol-%, based on the stoichiometry of the reaction, i.e. at least 1.1 mol, preferably at least 2 mol, more preferably at least 5 mol diisocyanate and most preferably at least 10 mol diisocyanate are used per mol functional group in the prepolymer precursor. The reaction preferably takes place under controlled reaction conditions, i.e. the prepolymer precursor is added so slowly under reaction conditions that heating of the reactor by more than 20 K is avoided. The reaction of the prepolymer precursor with the diisocyanate is preferably carried out in the absence of a solvent or diluent.

The reaction may take place in the absence or presence of small quantities of typical catalysts which promote the formation of urethanes. Suitable catalysts are, for example, tertiary amines, such as diazabicyclooctane (DABCO), and organotin compounds, for example dialkyl tin (IV) salts of aliphatic carboxylic acids, such as dibutyl tin dilaurate and dibutyl tin dioctoate. The quantity of catalyst is generally no more than 0.5% by weight, based on the prepolymer precursor, for example 0.01 to 0.5% by weight and, more particularly, 0.02 to 0.3% by weight. In a preferred variant, no catalyst is used.

The necessary reaction temperatures are of course dependent upon the reactivity of the prepolymer precursor used, upon the diisocyanate and upon the type and quantity of catalyst used, if any. They are generally in the range from 20 to 100° C. and more particularly in the range from 35 to 80° C. It goes without saying that the reaction of the prepolymer precursor with the diisocyanate takes place in the absence of moisture (<2,000 ppm, preferably, <500 ppm).

The reaction mixture thus obtained is generally worked up by distilling off the excess diisocyanate, preferably under reduced pressure. The reaction products obtained predominantly contain the star-like prepolymer which has isocyanate groups at the ends of the polymer arms. The percentage content of the star-like prepolymer is generally at least 70% by weight and preferably at least 80% by weight of the reaction product. The other constituents of the reaction product are largely dimers and—in small amounts—trimers which, in these quantities, are also suitable for the production of the coatings according to the invention.

Basically, there are no limits to the substrates to be coated with the star-like polymers according to the invention. The substrates may have regularly or irregularly shaped, smooth or porous surfaces. Examples of suitable surface materials are oxidic surfaces, for example silicates, such as glass, quartz, silicon dioxide as in silica gels, or ceramics, also semimetals, such as silicon, semiconductor materials, metals and metal alloys, such as steel, polymers, such as polyvinyl chloride, polyethylene, polymethyl pentenes, polypropylene, polyesters, fluorine polymers (for example Teflon®), polyamides, polyurethanes, poly(meth)acrylates, blends and composites of the above-mentioned materials, cellulose and natural fibers, such as cotton fibers and wool. The polymers may be woven or nonwoven materials.

According to the invention, the ultra-thin hydrogel-forming coatings are produced by deposition of the star-like prepolymers onto the surface to be coated from a solution of the prepolymers by methods known per se and subsequent crosslinking of the reactive groups of the prepolymers. If desired, the deposition and crosslinking steps may be carried out repeatedly. Thicker layers are obtained in this way.

Examples of deposition processes are immersion of the surface to be coated in a solution of the prepolymer and spincoating where a solution of the prepolymer is applied to the surface to be coated rotating at high speed. It goes without saying that the coating measures are generally carried out under dust-free conditions for the production of ultra-thin coatings.

In the immersion process, the substrates are immersed in a solution of the star polymer in a suitable solvent and the solution is allowed to drain off, leaving a thin liquid film of uniform thickness on the substrate which is then dried. The resulting film thickness depends on the concentration of the star polymer solution. Crosslinking is subsequently initiated.

In spincoating, the initially non-rotating substrate is generally completely wetted with a solution of the star-like prepolymer. The substrate to be coated is then rotated at high speeds, preferably above 1,000 r.p.m., for example 1,000 to 10,000 r.p.m., so that most of the solution is thrown off and a thin coating film is left on the surface of the substrate. Crosslinking is again subsequently initiated.

The concentration of the prepolymer in the solution will generally not exceed a value of 100 mg/ml, preferably 50 mg/ml and more particularly 20 mg/ml. The concentration is normally at least 0.001 mg/ml, preferably at least 0.005 and more particularly at least 0.01 mg/ml. The thickness of the coating can of course be controlled through the concentration, very low concentrations generally leading to monolayers of the star polymers on the coated surfaces.

The coating measures will generally be selected so that the coating thickness (as measured by ellipsometry using the method described in Guide to Using WVASE 32^{TH}, J. A. Woollam Co. Ind., Lincoln, Nebr., USA, 1998) does not exceed a value of 500 nm, preferably 200 nm and more particularly 100 nm. The process may also be used for the production of monolayers with thicknesses below 2 nm, for example 0.5 to 2 nm. Layer thicknesses of 1 to 100 nm and more particularly in the range from 2 to 50 nm are preferred for many applications.

Basically, suitable solvents are any solvents which have little or no reactivity towards the functional groups R of the prepolymer. Of these solvents, those which have a high vapor pressure and are therefore easy to remove are preferred. Accordingly, solvents with a boiling temperature below 150° C. and preferably below 120° C. at normal pressure are preferred. Examples of suitable solvents are aprotic solvents, for example ethers, such as tetrahydrofuran (THF), dioxane, diethylether, tert.butyl methyl ether, aromatic hydrocarbons, such as xylenes and toluene, acetonitrile, propionitrile and mixtures of these solvents. In the case of prepolymers containing OH, SH, carboxyl, (meth)acryl and oxirane groups, protic solvents, such as water or alcohols, for example methanol, ethanol, n-propanol, isopropanol, n-butanol and tert.butanol, and mixtures thereof with aprotic solvents are also suitable. In the case of prepolymers containing isocyanate groups, water and mixtures of water with aprotic solvents besides the aprotic solvents mentioned are, surprisingly, also suitable because the degradation of the isocyanate groups in the prepolymers presumably takes place comparatively slowly.

The crosslinking step can be carried out in various ways.

In one embodiment of the invention, the article coated with the uncrosslinked prepolymers is generally treated with a crosslinking agent.

Basically, suitable crosslinking agents are any polyfunctional compounds of which the functional groups react with the functional groups of the prepolymer to form a bond. These functional groups are also referred to hereinafter as complementary functional groups R′. An overview of complementary functional groups R′ is presented in Table 1 where the reactive groups R of the prepolymer are shown in the first line and the complementary groups R′ are shown in the first column:

TABLE 1
Complementary functional groups

| Reactive group R | Isocyanate | Acrylate/acrylamide | —SH | —NH₂ | —OH | Oxirane |
|---|---|---|---|---|---|---|
| Complementary | | | | | | |
| group R′ | | | | | | |
| Isocyanate | X* | | X | X | X | |
| Acrylate | | | X | X | X | |
| Acrylamide | | | X | X | X | |
| —SH | X | X | | | | X |
| —NH₂ | X | X | | | | X |
| —OH | X | X | | | | X |
| —COOH | X | | | | | |
| Oxirane | | | X | X | X | |
| Active ester | | | | X | X | |

*In the presence of water

Accordingly, one embodiment of the invention relates to a process in which crosslinking of the reactive groups R is initiated by addition of a compound V1 containing at least two reactive groups R′ per molecule which react with the reactive groups R of the star-like prepolymer to form a bond.

The polyfunctional compounds V1 may be low molecular weight compounds, for example aliphatic or cycloaliphatic diols, triols and tetraols, for example ethylene glycol, butanediol, diethylene glycol, triethylene glycol, trimethylol propane, pentaerythritol and the like, aliphatic or cycloaliphatic diamines, triamines or tetramines, for example ethylene diamine, diethylene triamine, triethylene tetramine, tetraethylene pentamine, 1,8-diamino-3,6-dioxaoctane, diaminocyclohexane, isophorone diamine and the like, aminoalcohols, such as ethanolamine, diethanolamine, aliphatic or cycloaliphatic dithiols, dicarboxylic acids or tricarboxylic acids, such as sebacic acid, glutaric acid, adipic acid, phthalic acid, isophthalic acid, or the diisocyanates mentioned above, depending on the type of reactive groups the prepolymer has. In contrast to the prepolymers, the low molecular weight polyfunctional compounds generally have a molecular weight of <500 g/mol.

The polyfunctional compound V1 may already be present in the solution of the prepolymer which is used for coating. In the coating of largely uncrosslinked prepolymers initially formed, the reactive groups R′ of the crosslinking agent then react with the reactive groups R of the prepolymer, for example during drying or during heating of the coating, and in doing so form a layer of inter-crosslinked prepolymers.

If the reactive groups R of the prepolymer are conjugated dienes, the compound V1 will, accordingly, contain at least two dienophilic groups and vice versa. If the prepolymers contain reactive groups which enter into an ene reaction, the compound V1 will contain at least two allylic double bonds. With systems such as these, solutions containing both the prepolymer and the compounds V1 will generally be used to produce the coatings. The crosslinking step is carried out during drying of the coating initially obtained, optionally after heating.

Basically, other suitable polyfunctional compounds V1 are prepolymers with at least four polymer arms A which are individually soluble in water and, at their free ends, carry a reactive functional group R′ which reacts with the reactive groups R of the prepolymer to form a bond. In other words, solutions of at least two different prepolymers, in which one prepolymer contains reactive groups R and the other prepolymer contains complementary reactive groups R′, may also be used for the process according to the invention. A layer of inter-crosslinked prepolymers is also obtained in this way.

In another embodiment of the invention, the linking of the reactive groups R is initiated by adding a sufficient quantity of a compound V2 which reacts with some of the reactive groups R to form reactive groups R′ which in turn react with the remaining reactive groups R to form a bond. In the case of prepolymers containing isocyanate groups, crosslinking may be initiated, for example, by treating the coated article with water, for example by storage in a moist atmosphere or in water. Some of the isocyanate groups react to form amino groups which in turn react with the remaining isocyanate groups to form a bond, a layer of inter-crosslinked prepolymers being formed. In this case, the crosslinking agent V2 is thus water.

In another embodiment of the invention, the group R is selected from ethylenically unsaturated, radically polymerizable double bonds. In this case, crosslinking is carried out thermally or photochemically, i.e. by exposure to UV radiation or electron beams. In the case of photochemical crosslinking by UV radiation, suitable photoinitiators will generally be added to the solution of the prepolymer. The type and quantity of photoinitiator needed to initiate photochemical crosslinking is well-known to the expert on radiation-curing paints.

In another embodiment of the invention, a star-like prepolymer is initially applied in the described manner, preferably as a monolayer, to the surface to be coated, the reactive groups R are optionally partly crosslinked and at least one other star-like prepolymer 2 is then applied to the surface thus treated, the star-like prepolymer 2 having at least four polymer arms A which are each soluble in water and, at their free ends, carry a reactive functional group R′ which has a reactivity complementary to the reactive groups R of the prepolymer 1. The remaining reactive groups R′ are then optionally re-crosslinked. This procedure may be repeated one or more times. Multilayer coatings can be selectively produced in this way. This procedure is also referred to hereinafter as the layer-by-layer process. The layer-by-layer process may be carried out particularly elegantly with prepolymers containing reactive groups R which react off with compounds V2 to form reactive groups R′ with a reactivity complementary to the groups R. Examples of groups R are isocyanate groups. In this case, the compound V2 is water and NH₂ groups are formed as the groups R′ with complementary reactivity. This is because, if the crosslinking of the first layer is initiated with the compound V2, the coating obtained has free groups R′ (for example amino groups) on its surface. These free groups R′ then react with the groups R (for example isocyanate groups) of the prepolymers applied in a second coating step to form a bond. The second coating step is also preferably controlled so that a monolayer of prepolymers is deposited onto the first coating. Accordingly, crosslinking of the second layer with compound V2 (for example water) and repetition of this procedure allows the production of highly crosslinked, highly ordered layers, particularly when the quantity of coating in each of the individual coating stages was selected so that monolayers would be obtained.

The coatings may also be produced with mixtures of star-like prepolymers and water-soluble polysaccharides, such as hyaluronates, heparins, alginates or, for example, dextran. Where prepolymers containing functional groups reactive to OH functions, for example isocyanate groups, are used, the polysaccharide acts as a crosslinking agent.

The process according to the invention also allows the selective incorporation of foreign materials, i.e. materials which do not form hydrogel-forming coatings, in the coating. Such foreign materials include bioactive materials, such as medicaments, oligonucleotides, peptides, proteins, signal substances, growth factors, cells, carbohydrates and lipids, inorganic components, such as apatites and hydroxyapatites, quaternary ammonium salt compounds, compounds of biguanidines, quaternary pyridinium salt compounds, compounds of phosphonium salts, thiazoyl benzimidazoles, sulfonyl compounds, salicylic compounds or organometallic compounds. Incorporation is preferably carried out by co-adsorption from solutions containing the prepolymer and the foreign constituent. In addition, the prepolymers may be reacted with the bioactive materials mentioned before adsorption or may be reacted on the surface as a mixture with non-modified prepolymers. It is of course also possible selectively to apply them to the hydrogel coating by physisorption or chemisorption.

Where coating is carried out by the layer-by-layer process, biological components may also be introduced in the form of an incompletely covering interlayer.

To this end, use is made of the fact that the uppermost layer of the star-like prepolymers generally still contains reactive groups which react specifically with commonly occurring groups of biomolecules, even under mild conditions (in aqueous solution, at room temperature). Examples are the reaction of NCO groups present on the surface of the polymer layer with alcohol, thiol or amino groups which are present in proteins and peptides or which can readily be introduced into many biomolecules by known methods. Another example is the Michael addition of thiol or amino groups onto acrylates and acrylamides in the uppermost layer of the coating. Another example is the reaction of activated esters in the uppermost layer of the coating with alcohol or amino groups of the biomolecules.

Examples of suitable biological components which can be introduced into the hydrogel coatings produced by the process according to the invention are medicaments, for example heparins, antibiotics, such as streptomycin, gentomycin, penicillin, neomycin, acriflavin, ampicillin, chitin, chitosan and chitosan derivatives and other bactericidal substances, growth factors, such as BMPs (bone morphogenic proteins), HGHs (human growth hormones), GMCSF (macrophage colony stimulating factors), factors binding to heparin, such as FGFs, VGFs, TGFs, communication- and architecture-imparting signal substances, such as BHL, HHL, OHL, DHLs, OHHL, OOHL, ODHL, OdDHL, HBHL, HtDHL and other integrin-imparting signal molecules, proteins, such as fibronectin, laminin, vitronectin, collagen, thrombospondin and other adhesion-promoting proteins, mechanically or other physically modulated proteins, such as stretched fibronectin, adhesion-promoting peptide sequences, such as RGD, RGDS, RGDV, RDT, LRGDN, LDV, REDV, IKVAV, YIGSR, PDSGR, DGEA, peptide sequences differing solely in a change in conformation, for example cyclic peptide sequences, amino acid sequences and oligonucleotides which allow molecular recognition, such as sequences of RNA or DNA, carbohydrates and lipids, such as sugars, and long-chain hydrocarbon compounds which allow interaction with the cell membrane, cells or cell formations of fibroblasts, osteoblasts, chondrocytes and other cell types and also pluripotent cell material.

It is often of advantage to pretreat the surface to be coated in such a way that it has an increased number (density per unit area) of functional groups R′ which are capable of reacting with the functional groups R of the prepolymers to form a bond.

To this end, the surfaces of inert materials will often be chemically activated before coating. This may be done, for example, by treating the surface to be coated with acid or alkalis, by oxidation (flame application), by electron bombardment or by a plasma treatment with an oxygen-containing plasma, as described by P. Chevallier et al. in J. Phys. Chem. B 2001, 105(50), 12490-12497; in JP 09302118 A2; in DE 10011275; or by D. Klee et al. in Adv. Polym. Sci. 1999, 149, 1-57.

The surface to be coated may also be treated with compounds which are known to show good adhesion to the surface and which, in addition, contain functional groups R′ complementary to the functional groups R of the star-like prepolymer. Depending on the reactive group R of the prepolymer, suitable groups R′ are isocyanate, amino, hydroxyl and epoxy groups, groups which react by Michael addition, dienophilic groups which enter into Diels-Alder addition reactions, electron-depleted double bonds which react with allylic double bonds in a Diels-Alder addition or ene reaction; activated ester groups; oxazoline groups; and vinyl groups and thiols which specifically enter into a free radical addition.

The nature of the group which effects adhesion to the surface to be coated does of course depend on the chemical nature of the surface to be coated. In the case of oxidic surfaces, such as ceramic and glass-like surfaces, and in the case of metallic surfaces, compounds containing silane groups, more particularly trialkoxysilane groups, as adhesion-promoting groups have proved to be effective. Examples of such compounds are trialkoxy aminoalkyl silanes, such as triethoxy aminopropyl silane and N-[(3-triethoxysilyl)propyl]ethylenediamine, trialkoxyalkyl-3-glycidyl ether silanes, such as triethoxypropyl-3-glycidyl ether silane, trialkoxy alkyl mercaptans, such as triethoxy propyl mercaptan, trialkoxy allyl silanes, such as allyl trimethoxy silane, and trialkoxy silyl acryloxyalkanes and acrylamidoalkanes, such as 1-triethoxysilyl-3-acryloxypropane. For oxidic materials and plastics, polyfunctional polyammonium groups are also suitable as adhesion-promoting groups. Examples of such compounds are polyammonium compounds containing free primary amine groups, as described for this purpose, for example, by J. Scheerder, J. F. J. Engbersen and D. N. Reinhoudt in Recl. Trav. Chim. Pays-Bas 1996, 115(6), 307-320 and by Decher, Science 1997, 277,1232-1237.

The above-mentioned compounds are preferably applied to the surface to be coated in the form of a monolayer. Such monolayers can be produced in known manner by treating the surfaces to be coated with dilute solutions of the compounds, for example by the immersion process described above or by spincoating. Solvents and concentrations correspond to the particulars mentioned for application of the prepolymers. It is often of advantage to treat the surfaces with the above-mentioned compounds which are known to show good adhesion to the surface after activation by flame application, by electron bombardment or by plasma treatment.

The surfaces coated in accordance with the invention swell on direct contact with water, aqueous solutions and moist gases to form highly stable hydrogels. In contrast to many known hydrogel-forming coatings, the coatings are stable even in the event of prolonged contact with aqueous solutions and can be repeatedly used because the deposits can be removed simply by rinsing with water. The coatings obtained in accordance with the invention effectively prevent the non-specific adsorption of proteins and cells over a long period and are superior to known hydrogel coatings in this respect. By virtue of their chemical composition, the coatings are biocompatible and non-toxic.

The use of the star-like prepolymers with reactive terminal groups advantageously enables simple coating processes, such as immersion, spincoating and, in particular, the layer-by-layer process, to be used.

In addition, the particularity of the star-like prepolymers with reactive terminal groups enables thin or ultra-thin hydrogel coatings with a layer thickness below 100 nm, preferably below 50 nm and, if desired, below 10 nm to be produced in a very simple and controlled manner. The coatings prevent the non-specific adsorption of proteins and the adhesion of cells and can thus prevent colonization by bacteria. The thinness of the coating is of particular advantage because the macroscopic properties and the appearance of the underlying material remain virtually unchanged.

In addition, the use of star-like prepolymers with reactive terminal groups readily enables ordered monolayers and multilayers to be produced, of which the structure and properties, such as water absorption, penetrability and flexibility, can be adjusted very precisely for the particular application.

The process according to the invention also uniquely enables various functions, for example biological agents, function centers, signal substances, growth factors, etc. to be incorporated in the individual hydrogel layers and, hence, a biofunctional coating to be transferred to substrates. The suppression of a non-specific bacterial colonization can be enhanced by the incorporation of bactericides, biological signal substances and colloidal particles preferably below 100 nm in diameter. On the other hand, the process according to the invention can be enhanced by the incorporation of bactericides, biological signal substances and colloidal particles preferably below 100 nm in diameter. On the other hand, the process according to the invention also enables colonization by specific bacteria and cells to be selectively promoted by the incorporation of biological signal molecules and ligands.

By virtue of the properties of the coatings obtained in accordance with the invention, the process according to the invention may be used for the production of microsensors and microanalysis systems, for the coating of microcannula for the introduction of genetic material into cells and for the coating of capillary systems where the adsorption of biological compounds onto the capillary surfaces is a major problem and can seriously impair analytical sensitivity. In other words, the use of star-like prepolymers for the production of hydrogel coatings opens up applications for which conventional polymers and hydrogels cannot be used or have not been used on account of their inadequate protein resistance.

The process according to the invention is also particularly suitable for the coating of articles which come into direct contact with living material, such as implants for example. The coatings may be applied to various laboratory instruments, medicinal products and medical instruments and also—on a pilot scale—to surfaces which have to be kept extremely clean, i.e. free from proteins and cells, or to which access for cleaning is difficult.

In addition, the coatings obtainable in accordance with the invention are particularly advantageous where only extremely thin coatings are possible. For example, the process according to the invention may be used for the production of ultra-thin coatings on the inner walls of tube and pipe systems which have particularly small diameters, for example in the μm range (implantable pump systems, thin catheters, laboratory equipment used in microbiology and genetic engineering). However, the process according to the invention is also suitable for the coating of extremely large surfaces (ships' hulls, industrial pipelines, swimming pools, operating theaters, etc.).

The invention is further illustrated by the following Examples.

### PRODUCTION EXAMPLES

1. Six-Armed Isocyanate-Terminated Polyethers.

In every case, a commercially available isophorone diisocyanate (IPDI: 72% cis- and 28% trans-isomer) was used as the isocyanate.

The prepolymer precursors used are commercially available 6-armed polyalkylene ethers (referred to in the following as polyols) which were obtained by anionic ring-opening polymerization from ethylene oxide and/or propylene oxide using sorbitol as initiator. The polyol used was dried before use to a residual water content of less than 350 ppm. Residues of the alkali metal hydroxide used for the production of the polyols were bound by neutralization with phosphoric acid.

In all the Production Examples, the polyol was slowly added (ca. 80 ml/h) by a pump, so that the reaction temperature deviated by no more than 10 degrees K from the temperature indicated.

The molecular weight (number average) was determined by gel permeation chromatography at room temperature in three columns connected in tandem (column 1: Waters μ-Styragel 1,000 Angström, I=30 cm; column 2: Waters μ-Styragel 100 Angström, I=30 cm; column 3: PSS SDV 50 Angström, I=60 cm) using tetrahydrofuran as eluent, a refractometry detector (Waters RI 2410) and using PSS Win-GPC V 4.02 evaluation software. The elution diagrams were adapted for evaluation to two Gauss curves, the percentage of di-/trimer being determined via the surface areas.

In addition, the characterization of the terminal groups of functionalized prepolymers and the functionalization yield were carried out where stated by elemental analysis (sulfur, nitrogen), by IR spectroscopy (v SH, C═O, NH) or by titration (unreacted OH groups).

The unreacted OH groups were determined by reacting the prepolymers with acetanhydride in pyridine and titrating excess acid (hydrolysis of the unreacted acetanhydride) with NaOH.

### Production Example 1

The polyol used is a 6-armed statistical poly(ethylene/propylene oxide) with an EO:PO ratio of 80:20 and a molecular weight of 3,100 g/mol. Before the reaction, 0.05% by weight phosphoric acid was added to the polyol, followed by heating with stirring for 1 h in vacuo to a temperature of 80° C.

262 g IPDI (1.18 mol) were introduced into a reactor and heated to 50° C. in an inert gas atmosphere. The dried and degassed polyol (50 g, 0.016 mol) was then slowly added (ca. 80 ml/h) with intensive stirring by means of a peristaltic pump. After the addition, the reaction mixture was stirred for another 60 hours at 50° C. Using a thin-layer distillation apparatus, excess IPDI was completely distilled off at 130° C./0.025 mbar pressure.

### Production Example 2

The polyol used corresponds to the polyol of Production Example 1.

210 g IPDI (0.94 mol) and 0.06 g (0.1% by weight) diazabicyclo-octane (DABCO) were introduced into a reactor and heated to 50° C. in an inert gas atmosphere. The dried and degassed polyol (58 g, 0.019 mol) was then slowly added (ca. 80 ml/h) with intensive stirring by means of a peristaltic pump. After the addition, the reaction mixture was stirred for another 60 hours at 50° C. Using a thin-layer distillation apparatus, excess IPDI was completely distilled off at 130° C./0.025 mbar pressure.

### Production Example 3

The polyol used is a 6-armed statistical poly(ethylene/propylene oxide) with an EO:PO ratio of 80:20 and a molecular weight of 10,000 g/mol. Before the reaction, 0.05% by weight phosphoric acid was added to the polyol, followed by heating with stirring for 1 h in vacuo to a temperature of 80° C.

IPDI (100 g, 0.45 mol) was introduced into a reactor and heated with stirring to 50° C. in an inert gas atmosphere. The dried and degassed polyol (50 g, 0.005 mol) was then slowly added (ca. 80 ml/h) with intensive stirring by means of a peristaltic pump. After the addition, the reaction mixture was stirred for another 60 hours at 50° C. The isocyanate-terminated star prepolymers were obtained after thin-layer distillation (100° C., 0.025 mbar).

### Production Example 4

The polyol used is a 6-armed polypropylene oxide with a molecular weight of 3,000 g/mol. Before the reaction, 0.05% by weight phosphoric acid was added to the polyol, followed by heating for 1 h in vacuo to a temperature of 80° C.

Using a peristaltic pump, 480 g (0.154 mol) of the polyol were slowly added (80 ml/h) in an inert gas atmosphere to an intensively stirred mixture heated to 50° C. of 840 g IPDI (3.78 mol) and 0.99 g dibutyl tin dilaurate (DBTL). After the addition, the reaction mixture was stirred for another 48 hours at 50° C. The isocyanate-terminated star prepolymers were obtained after thin-layer distillation (160° C., 0.01 mbar).

The prepolymers of Production Examples 5, 6, 7 and 9 were produced as described in Production Example 1. The prepolymers of Production Examples 8 and 10 were produced as described in Production Example 2. The molar ratio of diisocyanate to OH groups in the polyol (NCO/2/OH) is shown in Table 2. The percentages of monomolecular star-like polymers (mono-star) and bi- and trimolecular reaction products (bi- and tri-star), as determined by gel permeation chromatography, are also shown in Table 2.

### Production Example 11

30 g of a 6-arm statistical poly(ethylene oxide/propylene oxide) with an EO:PO ratio of 80:20 and a number average molecular weight of 12,000 were reacted with 50 g (0.23 mol) IPDI as in Production Example 1. The isocyanate-terminated star prepolymer was obtained after thin-layer distillation (100° C./0.001 mbar).

TABLE 2
Production Examples

| | | | | BI- AND |
|---|---|---|---|---|
| NO. | CATALYST | NCO/2/OH | MONOSTAR | TRI-STAR |
| 1 | None | 12/1 | 87% | 13% |
| 2 | 0.1% DABCO | 8/1 | 83% | 17% |
| 3 | None | 15/1 | 93% | 7% |
| 4 | DBTL | 4/1 | 85% | 15% |
| 5 | None | 2/1 | 46% | 54% |
| 6 | None | 8/1 | 82% | 18% |
| 7 | None | 4/1 | 69% | 31% |
| 8 | 0.1% DABCO | 4/1 | 81% | 19% |
| 9 | None | 6/1 | 81% | 19% |
| 10 | 0.1% DABCO | 12/1 | 82% | 18% |
| 11 | None | 15/1 | 100% | 0% |

2. Production of Star Polymers Containing Thiol, Acrylate, Acrylamide or NH₂ Groups

### Production Example 12

### Thiol-Terminated Star Polyether

A commercially available 6-armed polyethylene oxide with OH groups at the ends of the polyether chains was brominated with PBr₃ by a known method (Mills et al., J. Chem. Soc. Perkin Trans. 2, (4), 697-706, 1995, see also Tetrahedron 44(5), 1988, pp. 1553-1558 and Inorg. Chim. Acta 97(2) 1985, pp. 143-150 and generally J. March, Advances in Organic Synthesis, 3rd Ed., J. Wiley & Sons, New York 1985, p. 383), a 6-armed polyethylene oxide with bromine atoms at the ends of the polyether chains being obtained. It was predried in the manner described for Example 1. A solution of 15 eq. thioacetic acid in 200 ml ethanol containing 15 eq. sodium ethanolate was then slowly added dropwise at 100° C. After another 24 h, the thioacetate was hydrolyzed with 1N aqueous HCl. After hydrolysis of the thioacetate obtained as intermediate, the solution was stirred under nitrogen for another 2 hours at 78° C. The required thiol-group-containing product was separated off in the absence of air in a thin-layer distillation apparatus.

An IR spectrum of the product obtained showed a weak band at 2558 cm⁻¹ which may be assigned to the SH vibration. The sulfur content as determined by elemental analysis corresponds to a degree of functionalization of 5.1.

### Production Example 13

### Acrylate-Terminated Star Polyether

A solution of 40 g (12.9 mmol) of the predried polyether used in Production Example 1 in 400 ml dichloromethane was cooled to 0° C. A solution of 465 mmol pyridine and 465 mmol acryloyl chloride in 30 ml dichloromethane was then added over several hours. The reaction solution was stirred for another six hours at 0° C. and then for another 30 h at room temperature. The salt precipitated was filtered off and the filtrate was washed first with dilute hydrochloric acid and then with aqueous sodium hydrogen carbonate solution. The organic phase was dried over magnesium sulfate. The product was precipitated by addition of diethyl ether, filtered off and dried in vacuo.

An IR spectrum of the prepolymer showed an intensive characteristic band at 1730 cm⁻¹ which may be assigned to the C═O vibration. Titrimetric determination of the OH group content revealed a degree of functionalization of >5.

### Production Example 14

### Amine-Terminated Star Polyether

A saturated solution of 100 g (32.3 mmol) of the predried polyether used in Production Example 1 in 400 ml dichloromethane was cooled under nitrogen to 0° C. 580 mmol pyridine and then 580 mmol methanesulfonyl chloride were very slowly added. After 24 h, the deposit precipitated was filtered off and the mesylate formed was precipitated by addition of diethyl ether. The mesylate obtained was dissolved in dimethyl formamide and the resulting solution was stirred for 24 hours at 60° C. with 1.16 mol sodium azide. After cooling, the mixture was diluted with water and extracted with dichloromethane. The organic phase was then dried over magnesium sulfate and the product was precipitated by addition of diethyl ether, filtered and dried in vacuo. The azide-functionalized polyether thus obtained was dissolved in dry tetrahydrofuran and the solution was added dropwise to a suspension of 290 mmol LiAlH₄ in tetrahydrofuran. The mixture was stirred for 16 h at 60° C. and, after cooling, 15% sodium hydroxide was slowly added until a white granular deposit had formed. The product was filtered through silica. The amine-terminated polyether was precipitated from the resulting solution by addition of diethyl ether and dried in vacuo.

An IR spectrum of the prepolymer shows a sharp band at 3310 cm⁻¹ which may be assigned to the NH vibration. The nitrogen content as determined by elemental analysis corresponds to a degree of functionalization of >5.

### Production Example 15

### Acrylamide-Terminated Star Polyether

A solution of 30 g (ca. 9.6 mmol) of the predried amine-terminated polyether of Production Example 14 in 300 ml toluene was cooled under nitrogen to 0° C. and diluted with dichloromethane until a clear solution had formed. 320 mmol pyridine and then—over several hours—320 mmol acryloyl chloride were added to the solution. After the addition, the mixture was stabilized with BHT, stirred for at least another 6 h at 0° C. in the absence of air and concentrated to 200 ml. The salt precipitated was filtered off and the filtrate was introduced into 500 ml cold diethyl ether. A solid was obtained and was dissolved in 200 ml distilled water. 10 g NaCl were added to the solution. The pH was adjusted to 7 by addition of 1N NaOH and the neutralized solution was repeatedly extracted with dichloromethane. The organic phases were combined and diethyl ether was added, resulting in the precipitation of a solid. The solid was taken up a second time in dichloromethane and, after the addition of a stabilizer, was re-precipitated in 500 ml cold diethyl ether, filtered off and dried in vacuo. The acrylamide-terminated star polyether was obtained in this way.

An IR spectrum shows a strong band at 1670 cm⁻¹ which may be assigned to the amide EO group. The nitrogen content as determined by elemental analysis corresponds to a degree of functionalization of >5.

II. Production of the Hydrogel Coatings

Small glass plates (floated glass, quartz glass, standard glass) and hydrophilic silicon wafers (Si[100]) were used as the substrates. Before coating, the substrates were cleaned first in acetone, then in millipore water and finally in isopropanol in an ultrasonication bath. Basically, all the substrates were stored under a layer of liquid in suitable protective containers in order to avoid contamination by dust and fatty droplets from the atmosphere.

The water used was deionized (18 MΩ-cm or better). All solutions were passed through a 0.05μ filter to remove dust and particulate impurities. Filtered deionized water is also referred to hereinafter as millipore water.

Coating in the absence of water was carried out in a glove box (Braun) in an atmosphere with a water content of less than 1 ppm H₂O/O₂.

1. Aminofunctionalization of the Substrates

1.1 Using a TePla 100-E plasma unit (Plasma Systems), the cleaned substrates were treated for 10 mins. in an oxygen plasma (pressure: 0.15 mbar). The substrates thus treated were then stored in deionized water.

For aminofunctionalization, the substrate surface was first coated with an aminosilane monolayer as promoter. To this end, the sample removed from the water and blow-dried with nitrogen was transferred to a glovebox where the substrates were stored for 16 h in a 0.4% (v/v) solution of N-(3-(trimethoxysilyl)-propyl)-ethylenediamine in dry toluene, then thoroughly washed with toluene and, before use, were dried under nitrogen in the glovebox using a filtered stream of nitrogen.

1.2 Alternatively, the substrates were treated with oxygen for 10 mins. under a 40 W UV lamp (distance between substrate surface and light source 2 mm) and then placed in millipore water (MP-H₂O). The sample removed from the MP-H₂O and blow-dried with nitrogen was then treated as in 1.1 with (trimethoxysilyl)-propyl)-ethylenediamine.

2. Coating of the Substrates

All measures were carried out under dust-free conditions (clean room conditions).

2.1 Coating by Immersion

General Procedure a)

The substrates aminofunctionalized as described in 1.1 are immersed in a solution of the particular prepolymer in dry THF (0.05 mg/ml to 5 mg/ml). The solution is carefully allowed to drain off so that a thin liquid film of uniform thickness is left on the substrate. The film is then predried. The resulting film thickness depends on the concentration of the star polymer solution. The samples—protected from dust—are then removed from the glovebox and reacted in a moist atmosphere. The samples are placed in MP-H₂O pending use/analysis.

General Procedure b)

The substrates aminofunctionalized as described in 1.1 are immersed in a freshly prepared solution of the prepolymer (0.005 mg/ml to 20 mg/ml in 1:1 THF:MP-H₂O). The solution is carefully allowed to drain off so that a thin liquid film of uniform thickness is left on the substrate. The film is then dried. After the film has finished reacting, the samples are placed in MP-H₂O pending use.

Table 3 lists tests and resulting layer thicknesses obtained by immersion coating. The layer thicknesses were determined by ellipsometry “Guide to using WVASE32 TM”, J. A. Woollam Co., Ind., Lincoln, Nebr., USA 1998).

TABLE 3

| Prepolymer | | | | |
|---|---|---|---|---|
| Production | Concentration | | | |
| Example | [mg/ml] | Procedure | Solvent | Layer thickness |
| No. 3 | 0.005 | b | THF/H₂O | 1.3 nm |
| No. 3 | 0.05 | b | THF/H₂O | 3.0 nm |
| No. 3 | 0.5 | b | THF/H₂O | 4.9 nm |
| No. 3 | 1.0 | b | THF/H₂O | 12.0 nm |
| No. 3 | 20.0 | b | THF/H₂O | 23.0 nm |
| No. 1 | 0.05 | a | THF | 4-5 Å |
| No. 1 | 2.0 | a | THF | 7-8 Å |
| No. 1 | 5.0 | a | THF | 9-10 Å |

2.2 Coating by Spincoating of a Thin Polymer Layer (General Procedure)

The coating of aminofunctionalized substrates produced as described in 1 was carried out using a spincoater (SPS model WS-400A-6TFM/lite). To this end, the non-rotating dried substrate is first completely wetted with the prepolymer solution (0.05 mg/ml to 5 mg/ml star polymer in THF) before the solution is “thrown” off for 40 seconds at acceleration stage “5” and at a final speed of 5,000 r.p.m. The sample is now dry. The substrates thus coated were stored overnight under dust-free conditions in 50 to 80% air humidity. The samples thus treated may then immediately be put to the required use or placed in MP-H₂O pending use.

In a variant of the process described above, the aminofunctionalized substrate produced as described in 1 is rinsed with deionized water while rotating (3,000 r.p.m.) on the spincoater before being coated with a freshly prepared water-containing star polymer solution in THF. Better wetting of the substrate and a very thin polymer film are obtained in this way.

The results are set out in Table 4. The layer thickness was determined by ellipsometry.

TABLE 4

| Prepolymer | Concentration | | |
|---|---|---|---|
| Production Example | [mg/ml] | Layer thickness | |
| No. 3 | 0.005 | 0.9 | nm |
| No. 3 | 0.01 | 3.1 | nm |
| No. 3 | 0.05 | 5.4 | nm |
| No. 3 | 0.1 | 7.5 | nm |
| No. 3 | 0.5 | 11.4 | nm |
| No. 3 | 1.0 | 14.6 | nm |
| No. 3 | 2.5 | 15.5 | nm |
| No. 3 | 5.0 | 43.2 | nm |
| No. 3 | 10.0 | 112.0 | nm |
| No. 3 | 20.0 | 211.2 | nm |
| No. 1 | 0.5 | 7-9 | nm |
| No. 1 | 1.0 | 12-13.5 | nm |
| No. 1 | 2.0 | 14-17 | nm |

3. Layer-by-Layer Coating

3.1 General Procedure for the Production of Monolayers by Spincoating

The substrates aminofunctionalized and washed as described in 1 are carefully blow-dried in a filtered stream of nitrogen on the spincoater. The substrate is gently heated with the nitrogen preheated to 50° C. before a solution of the prepolymer from Production Example 1 (in THF; 0.5 to 5 mg/ml, see III-1) is applied by spincoating in the absence of moisture (SPS spincoater model WS-400A-6TFM/lite: acceleration stage “2”, speed 1500 r.p.m.). Before the film has dried completely, the surface of the still rotating substrate is repeatedly washed by application of a drop of water-free dichloromethane in order to remove excess prepolymer. In order to obtain a dense monofilm, the procedure is repeated. The sample thus coated is then crosslinked by placing in MP-H₂O. The procedure is repeated according to the number of monolayers to be applied.

3.2 General Procedure for the Production of Monolayers by Immersion:

The substrates pretreated as described in 1 are placed for 1 h in a solution of the prepolymer in water-free THF in the absence of moisture. The samples are then repeatedly washed with water-free THF to remove non-chemically bound prepolymer molecules. The samples are then placed in MP-H₂O for 1 hour. The sample is dried and then placed in a THF bath to remove water from the coating. The samples are then dried in a dust-free atmosphere or in a filtered stream of nitrogen. To apply another monofilm, this procedure is repeated, beginning with immersion of the sample in the water-free solution of the prepolymer in THF. The samples thus coated may then immediately be put to the required use or placed in MP-H₂O pending use.

III. Evaluation of the Polymer Films

1. Analysis of the Dependence on Concentration of the Thickness of a Monolayer

Silicon wafers pretreated as described in II-1. were placed in a solution of the prepolymer of Production Example 1 in water-free THF. After immersion, the samples were repeatedly washed with water-free THF. After one hour in MP-H₂O, the samples were removed and dried as described in II-3.2. The layer thickness of the hydrogel films obtained was determined by ellipsometry. The results are set out in Table 5.

TABLE 5

| Concentration | Layer thickness |
|---|---|
| [mg/ml] | [nm] |
| 0 | 0.28 |
| 0.5 | 0.4 |
| 1 | 0.45 |
| 2 | 0.75 |
| 5 | 0.9 |

The values in Table 5 show that layer thickness initially increases considerably with increasing concentration of the prepolymer solution and approaches a limit at high concentrations (e.g. 5 mg/ml). It is assumed that, at low concentrations, more NCO groups enter into covalent bonds with reactive groups at the surface on account of the lower surface coverage level. By contrast, a relatively high concentration presumably leads to a close-packed adsorbate layer of star molecules with less anchorage to the surface through the NCO groups.

2. Evaluation of Layer Thickness as a Function of the Number of Layers Applied

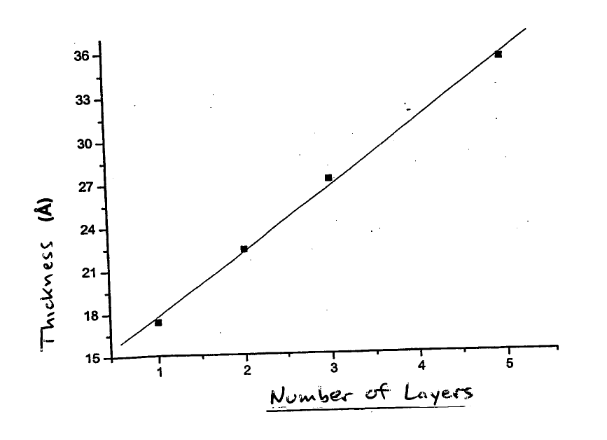

A monolayer was first produced as described in 1. using a solution of the prepolymer of Production Example 1 in THF with a concentration of 1.0 mg/ml. The substrate thus coated was then placed in a solution of the same prepolymer in water-free THF (concentration 1.0 mg/ml). The sample was then washed repeatedly with water-free THF. After one hour in MP-H₂O, the samples were removed and dried as described above. This procedure was repeated a total of five times, layer thickness being determined by ellipsometry after each application of another layer. The results are shown in FIG. 1.

As can be seen from FIG. 1, the layer thickness increases linearly as the number of layers increases; the slope of the linear equalizing curve is ca. 4.7 Å/layer which corresponds to the thickness of one monolayer.

3. Determination of the Swelling of a Thin Hydrogel Layer in Water

Swelling behavior was evaluated by ellipsometry on a thin coating. The change in layer thickness, which directly reflects the swelling behavior of the hydrogel layer, was measured in situ.

The samples were pretreated as described in II-1. After drying of the sample in a filtered stream of nitrogen, a solution of the polymer from Production Example 1 (5 mg/ml in dry THF) was applied by spincoating at a speed of 6,000 r.p.m. (40 secs.), as described in II-2.2. The sample thus produced was then stored in water for 1 hour and, after drying in a stream of filtered nitrogen, was dried for 30 mins. at 90° C./0.1. The dried sample was then exposed to the laboratory atmosphere (20° C., 60% relative air humidity) and the change in layer thickness caused by water absorption was evaluated in situ by ellipsometry. The evaluation results are shown in FIG. 2.

As can be seen from FIG. 2, the layer thickness of the dried sample initially increases continuously through contact with the moist air. After ca. 10 h, there is no sign of any further increase in layer thickness. The total relative increase in layer thickness is ca. 2%, which corresponds to an absolute increase of a few Angströms.

4. Evaluation of the Adsorption of Biopolymers by Observation of the Diffusion of Individual Molecules

Recessed glass slides and cover glasses (Thickness=170 μm) were used as substrates and were first pretreated as described in II-1. The substrates used were then coated with the prepolymer from Production Example 3 in the manner described for 11-2.2 (spincoating of a 5 mg/ml solution of prepolymer in dry THF at a speed of 5,000 r.p.m.).

Evaluation was carried out by confocal laser microscopy and by confocal fluorescence correlation spectroscopy (FCS) using the fluorescent dye MR 121. The dye was diluted to a concentration of 10⁻¹⁰ M with PBS buffer (140 mM NaCl, 10 mM KCl, 6.4 mM Na₂HPO₄×2H₂O, 2 mM KH₂PO₄). 120 μl of the solution were pipetted into the ca. 100 μl recess of the above-mentioned slide and covered with the 170 μm thick coated cover glasses. An uncoated glass slide and an untreated cover glass were used as reference.

For the confocal laser microscopy, the slide with the sample was positioned over the microscope objective with the cover glass underneath. By moving the objective, the laser focus was focussed ca. 10 μm above the cover glass into the sample solution.

In this way, the interaction of the dye (MR 121) and also the oligonucleotides (MR 121-IPs) marked with the dye in solutions of 10⁻⁹-10¹⁰ M in a volume of ca. 1 μm³ can be directly observed at the glass surface. In order to observe the conditions directly at the surface, the excitation light of the laser was focussed onto the glass surface in such a way that the reflex caused by the glass/water transition was maximal. It was found that, in the case of the reference, the marked oligonucleotides adsorb from the PBS (additionally containing 5 mM MgCl₂) solution and could then no longer be freely moved. In the micrographs, the individual molecules could then be localized at the surface. By contrast, in the sample space coated in accordance with the invention, the oligonucleotides are freely movable—as in solution—and cannot be localized as in solution, so that increased background fluorescence was measured for the micrograph as a whole.

The interaction of the dye oligonucleotides (MR 121-IPS) from 10⁻⁹-10¹⁰ M with the surface can be quantitatively measured by confocal fluorescence correlation spectroscopy (FCS) (see also M. Sauer et al., Anal. Chem. 2000, 72, 3717-3724). FCS curves of homogeneous solutions, i.e. all fluorophores, behave in the same way and, disregarding triplet terms, can be described by a sigmoidal fit. Its inflection point corresponds to a mean diffusion time for the movement of a fluorophore through the detection volume. The longer the mean diffusion time, the smaller the interaction of the fluorophore with its surroundings or the longer the diffusion times of the fluorophore, the stronger the adhesion of the marked molecule to the surfaces being investigated. This may be used as a quality feature of a non-adhesive coating.

If the FCS curve for the sample of MR 121-IP (T30) in the region of the uncoated glass surface (glass, focussed to 0 μm) is described by a sigmoidal curve, an inflection point of ca. 1 second is obtained. This is indicative of a very strong interaction of the dye with the glass surface. By contrast, the FCS curve for a sample of MR 121-IP (T30) on a surface coated in accordance with the invention (hydrogel, focussed to 0 μm) has an inflection point at 238 μs which almost corresponds to that of a freely diffusing MR 121-IP. If the detection volume is moved 4 μm into the solution, no further surface influence can be observed in the case of the glass coated in accordance with the invention. In the case of the glass surfaces, it can be seen that the FCS curve (glass, focussed to 4 μm) has an inflection point at 23.5 ms which is again indicative of very distinct interactions of the fluorescence-marked oligonucleotide with the surface. Only when the detection volume was moved 40 μm into the solution did both curves approximate the freely movable MR 121-IP. The diffusion times obtained for MR 121-IP (T30) are shown in Table 6.

TABLE 6
Mean diffusion times of MR 121 on and at various levels above
a glass or hydrogel surface

| | |
|---|---|
| | Mean diffusion time |
| Position of the detection | MR 121-IP (T30) [ms] |

| volume | Glass surface | Coated surface |
|---|---|---|
| 0 μm | 1108 | 0.238 |
| 4 μm | 23.5 | 0.215 |
| 40 μm | 0.190 | 0.197 |

5. Cell Adhesion Experiments

The cell adhesion experiments were carried out with GFP actin 3T3 fibroblasts (chicken) and MC3T3-E1 osteoblasts (chicken). The cells were stored in 50 ml PMMA cell culture boxes at 37° C./5% CO₂ in a steam-saturated atmosphere in an incubator and replicated. The cell media used are standard cell media. For fibroblasts, the cell medium consisted of an aqueous solution of 88% by vol. DMEM (Dulbecco's Modified Eagle's Medium, Biochrom KG) with 10% by vol. foetal calf serum (FCS, Invitrogen), 1% by vol. penicillin solution (penstrep. Sigma), 1% by vol. glutamine (Invitrogen) and 0.5 mg/ml antibiotic, Geneticin (Sigma). For the osteoblasts, the cell medium was prepared from an aqueous solution of 94% by vol. α-MEM (α-modified eagle's medium) with 5% by vol. calf serum (FCS, Invitrogen) and 1% by vol. glutamine (Invitrogen). The cells were regularly split to guarantee maximum growth and to obtain the GFP expression.

Adhesion experiments were carried out in sterile PS Petri dishes (50 mm diameter). Before addition to the Petri dishes, the cells were removed from the cell culture boxes with 2 ml trypsin per Petri dish and then deposited as sediment in a centrifuge (10 mins. at 1,000 r.p.m.). Re-diluted with medium, the cell suspension was then pipetted onto the substrates and incubated. If the cells adhere to the substrate, they form a uniform layer which can clearly be seen with an optical microscope. If the cells are unable to anchor themselves to the substrate, i.e., if adhesion of the cells to the substrate is suppressed, the cells die off and can be seen on the surface as small, round piles.

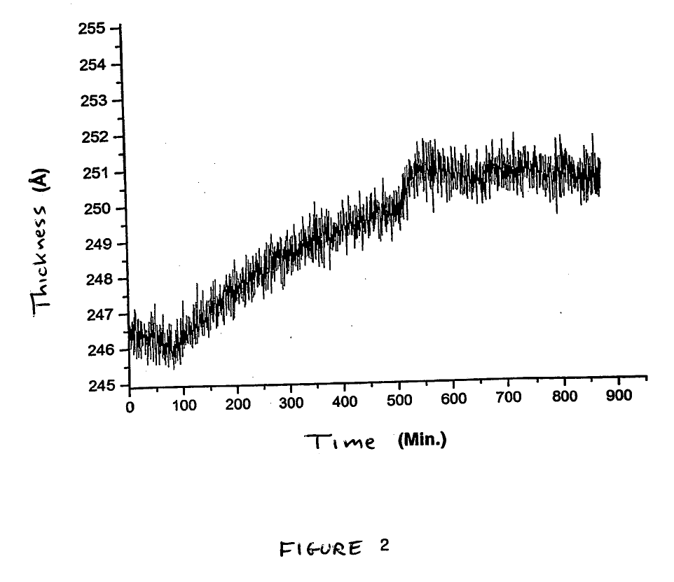

The substrate used in test 1 was a glass plate coated in accordance with the invention, which had been produced by spincoating of a glass plate pretreated as in II-1. with a solution of the prepolymer from Production Example 3 (5.0 mg/ml) by the method described in II-2.2. The thickness of the coating was ca. 50 nm. The sample was then treated with the cell suspension as described above and examined with an optical microscope. The results are shown in FIG. 3.

FIG. 3 shows that the coating is cell-resistant because the cells have died off and can be seen as small, round piles on the surface. Even after 120 h, the surface shows no cell growth which is proof of the long-term effect and stability of the coating. Similar results are also obtained with thinner coatings with a thickness of ca. 5 nm.

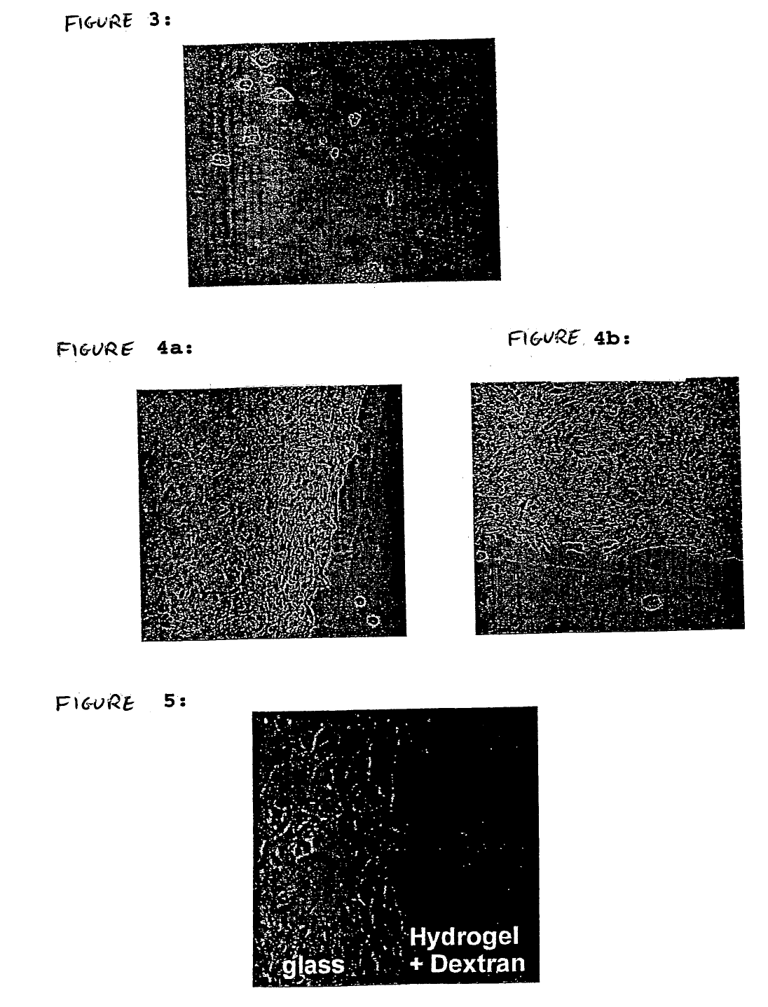

The substrates used in tests 2 and 2a were glass plates which had been coated with a solution of the prepolymer from Production Example 3 (5.0 mg/ml or 1 mg/ml) by spincoating by the method described in II-2.2. The thickness of the coating used to prepare the coated substrate shown in FIG. 4a was ca. 5 nm. The thickness of the coating used to prepare the coated substrate shown in FIG. 4b was ca. 15 nm. Half was then dip-coated with polystyrene (1.0 mg/ml or 2.5 mg/ml in THF). The sample was then treated with the cell suspension as described above and examined with an optical microscope. The results are shown in FIGS. 4a and 4b.

FIGS. 4a and 4b show that the cells colonize the surface treated with polystyrene and die off on the surface treated in accordance with the invention.

The substrates used in test 3 were glass plates which had been half-coated with a mixture of prepolymers from Production Example 3 (5.0 mg/ml) and dextran dissolved in water (20 mg/ml, Thickness=30 nm) by dipcoating by the method described in II-2.1b. The sample was then treated with the cell suspension as described above and examined with an optical microscope. The results are shown in FIG. 5.

FIG. 5 shows that the cells colonize the untreated surface and die off on the surface treated in accordance with the invention.

1. A method of forming a coating on a surface, said method comprising applying to said surface star-like prepolymers having, on average, at least four polymer arms A which are individually soluble in water and which have free ends carrying a functional group R which is reactive with a complementary reactive functional group R′ or with itself.

2. The method claimed in claim 1, wherein the functional group R is selected from isocyanate groups, (meth)acrylic groups, oxirane groups, or carboxylic acid ester groups and the complementary reactive group R′ is selected from primary and secondary amino groups, thiol groups, carboxyl groups, or hydroxyl groups.

3. The method claimed in claim 1, wherein the reactive group R is selected from ethylenically unsaturated, radically polymerizable double bonds.

4. The method claimed in claim 1, wherein the star-like prepolymers have on average 6 to 8 polymer arms.

5. The method claimed in claim 1, wherein the star-like prepolymers have a number average molecular weight of 2,000 to 20,000 g/mol.

6. The method claimed in claim 1, wherein the polymer arms A have a number average molecular weight of 300 to 3,000 g/mol.

7. The method claimed in claim 1, wherein the polymer arms A are selected from the group consisting of poly-C₂₋₄-alkylene oxides, polyoxazolidones, polyvinyl alcohols, homopolymers and copolymers containing at least 50% by weight (co)polymerized N-vinyl pyrrolidone, homopolymers and copolymers containing at least 30% by weight (co)polymerized acrylamide and/or methacrylamide, and homopolymers and copolymers containing at least 30% by weight (co)polymerized acrylic acid and/or methacrylic acid.

8. The method claimed in claim 1, wherein the polymer arms A are selected from the group consisting of polyethylene oxides, polypropylene oxides and polyethylene oxide/polypropylene oxide block copolymers.

9. The method claimed in claim 1, wherein the star-like prepolymers are applied to the surface in the form of an aqueous preparation.

10. A process for producing an ultra-thin, hydrogel-forming coating on a surface, said process comprising:
i. applying a solution of star-like prepolymers having, on average, at least four polymer arms A which are individually soluble in water and, at their free ends, carry a reactive functional group R; and
ii. carrying out a reaction to link the reactive functional groups R with one another and/or with a complementary reactive functional group R′.

11. A process as claimed in claim 10, wherein the quantity of star-like prepolymers applied to the surface is selected so that a coating with a thickness of less than 50 nm is obtained.

12. A process as claimed in claim 10, wherein the concentration of star-like prepolymers in the solution is 0.001 mg/ml to 100 mg/ml.

13. A process as claimed in claim 10, wherein the surface to be coated is pretreated to provide complementary reactive functional groups R′ on the surface.

14. A process as claimed in claim 10, wherein the surface is treated in an oxygen-containing plasma before applying the solution.

15. A process as claimed in claim 10, wherein the surface is pretreated with a silane compound containing a complementary functional reactive group R′.

16. A process as claimed in claim 10, wherein the linking of the reactive functional groups R is initiated by a compound V1 containing at least two reactive groups R′ per molecule which react with the reactive functional groups R of the star-like polymers to form bonds.

17. A process as claimed in claim 10, wherein the linking of the reactive functional groups R is initiated by adding a compound V2 which reacts with some of the reactive functional groups R to form reactive groups R′ which in turn react with the remaining reactive functional groups R.

18. A process as claimed in claim 17, wherein the reactive functional groups R are isocyanate groups and the compound V2 is water.

19. A process as claimed in claim 10, wherein the reactive functional groups R are selected from ethylenically unsaturated, radically polymerizable double bonds and said linking is thermally or photochemically initiated.

20. A process for forming a coating on a surface, said process comprising:
a) applying a star-like prepolymer 1 with at least four polymer arms A, which are each soluble in water and which each have a free end carrying a reactive functional group R, to the surface to be coated, an initial coating containing reactive functional groups R at its surface being obtained; and
b) applying at least one other star-like prepolymer 2 with at least four polymer arms A′, which are each soluble in water and which each have a free end carrying a reactive functional group R′ which is capable of reacting with the reactive groups R of the star-like prepolymer, is applied to the initial coating.

21. A process for forming a coating on a surface, said process comprising:
a) applying a star-like prepolymer 1 with at least four polymer arms A, which are each soluble in water and which each have a free end carrying a reactive functional group R to the surface to be coated;
b) adding to the surface to be coated a compound V2, which reacts with some of the reactive functional groups R to form reactive groups R′ which in turn react with the remaining reactive groups R, thereby obtaining an initial coating with functional groups R′ on its surface;
c) applying at least one other star-like prepolymer 1 to the initial coating; and
d) adding a compound V2 to the initial coating and reacting said compound V2 with said at least one other star-like prepolymer 1 applied in step c).

22. A process as claimed in claim 10, wherein at least one material selected from the group consisting of biologically active materials and cell materials is incorporated in the coating.
